(19) United States
(12) Patent Application Publication
(10) Pub. No.: US 2016/0034171 A1
(43) Pub. Date: Feb. 4, 2016

(54) MULTI-TOUCH GESTURE RECOGNITION USING MULTIPLE SINGLE-TOUCH TOUCH PADS

(71) Applicant: Flextronics AP, LLC, Broomfield, CO (US)

(72) Inventor: Zbynek Jerie, Nurtingen (DE)

(73) Assignee: Flextronics AP, LLC, Broomfield, CO (US)

(21) Appl. No.: 14/450,446

(22) Filed: Aug. 4, 2014

(51) Int. Cl. G06F 3/0488; G06F 3/0484

(52) U.S. Cl. CPC G06F 3/04883; G06F 3/04845

(57) ABSTRACT

Described herein is a device and method that uses multiple touch-sensors on multiple ergonomically separated surfaces together with centralized, common processing to enable multi-touch performance for multi-touch applications. The device uses a combination of two or more separate touch-sensors with common processing to allow use of a wider portfolio of touch technologies which would otherwise only offer single-touch capabilities, for multi-touch applications. The usage of multiple separated sensors allows coverage of various surfaces using sensor technologies that might otherwise be unavailable. The segmented ergonomically formed touch sensitive devices use ergonomic single-touch and multi-touch gestures for controlling or passing general input information to electronic devices having a human-machine input. The devices fit a variety of surface conditions and are operable via a combination of a number of different human body parts. The multiple touch sensors are ergonomically separated or dedicated to body parts to prevent accidental activation by unintended body parts.

### FIELD OF INVENTION

This application is related to human-machine input devices.

### BACKGROUND

Many of today's electronic devices offer human-machine-interface through touch sensitive devices such as touch-pads or touch-screens. These touch sensitive devices may be implemented using a variety of technologies including capacitive or resistive sensors, piezoelectric or otherwise force-sensitive pads, various optical methods and the like. Every such technology has its advantages and disadvantages. Some of these technologies are capable of recognizing two or more simultaneous touches, some are able to recognize only a single touch. On the other hand, some of the single touch technologies may offer other features like better electromagnetic compatibility (EMC), additional measurement of touch pressure or force, or lower cost, and so the final choice of technology is driven by many compromises. Moreover the corresponding mass-produced sensors are often limited in the types of surface curvatures that they are able to cover. This often results in plain or only slightly curved interaction surfaces which are not the most suitable or ergonomic for the human anatomy.

### SUMMARY

Described herein is a device and method that uses multiple touch sensors on multiple ergonomically separated surfaces together with centralized, common processing to enable multi-touch performance for multi-touch applications. The device uses a combination of two or more separate touch-sensors with common processing to allow the use of a wider portfolio of touch technologies, even such, which would otherwise only offer single-touch capabilities, for multi-touch applications. Additionally, the usage of multiple separated sensors allows coverage of surfaces of forms that would, if covered with a single large sensor, cause high costs or even make it impossible for some sensor technologies to be used. The segmented ergonomically formed touch sensitive devices use ergonomic single-touch and multi-touch gestures for controlling or passing general input information to electronic devices having a human-machine input. The devices fit a variety of surface conditions and are operable via a combination of a number of different human body parts. In particular, the multiple touch sensors are ergonomically separated or dedicated to some body parts such that the user is easily able to keep for example one of their fingers (finger_1) on one sensor (sensor_1) and another finger (finger_2) on other sensor (sensor_2) without accidentally touching sensor_1 with finger_2 or vice versa.

### BRIEF DESCRIPTION OF THE DRAWINGS

FIG. 1 is an example of a touch sensitive device with multiple touch sensors in accordance with an embodiment;

FIG. 2 is an example steering wheel using a touch sensitive device with multiple touch sensors in accordance with an embodiment;

FIG. 3 is a perspective view of a device with multiple touch sensors with a user's hand in accordance with an embodiment;

FIG. 4 is an example of a touch sensitive device with multiple touch sensors in a representative coordinate system with examples of touch movement directions;

FIG. 5 is an example high level block diagram of a touch sensitive device in accordance with an embodiment;

FIGS. 6A-6C provide example high level block implementations in accordance with embodiments;

FIG. 7 is an example of a two-hand multi-touch gesture using two touch pads, each dedicated to an activation member;

FIG. 8 is another example of a two-hand multi-touch gesture using two touch pads, each dedicated to an activation member;

FIG. 9 is another example use of a touch pad in accordance with an embodiment;

FIG. 10 is another example use of a touch pad in accordance with an embodiment;

FIG. 11 is another example use of a touch pad in accordance with an embodiment;

FIG. 12 is another example use of a touch pad in accordance with an embodiment;

FIG. 13 is another example use of a touch pad in accordance with an embodiment; and

FIG. 14 is another example use of a touch pad in accordance with an embodiment.

### DETAILED DESCRIPTION

It is to be understood that the figures and descriptions of embodiments of a device and method that uses multiple touch sensors on multiple surfaces together with centralized, common processing to enable multi-touch performance for multi-touch applications have been simplified to illustrate elements that are relevant for a clear understanding, while eliminating, for the purpose of clarity, many other elements found in typical human-machine input (HMI) systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

The non-limiting embodiments described herein are with respect to a device and method that uses multiple touch sensors on multiple surfaces together with centralized, common processing to enable multi-touch performance for multi-touch applications. Other electronic devices, modules and applications may also be used in view of these teachings without deviating from the spirit or scope as described herein. The device and method that uses multiple touch sensors on multiple surfaces together with centralized, common processing to enable multi-touch performance for multi-touch applications may be modified for a variety of applications and uses while remaining within the spirit and scope of the claims. The embodiments and variations described herein, and/or shown in the drawings, are presented by way of example only and are not limiting as to the scope and spirit. The descriptions herein may be applicable to all embodiments of the device and method that uses multiple touch sensors on multiple surfaces together with centralized, common processing to enable multi-touch performance for multi-touch applications although it may be described with respect to a particular embodiment. Although the descriptions herein refer to hands, fingers and thumbs, any human body part may be used in any combination. In addition, a pen, stylus, prosthetics and other like devices may be used.

In general, described herein is a device and method that uses multiple touch sensors on multiple ergonomically separated surfaces together with centralized, common processing to enable multi-touch performance for multi-touch applications. The device uses a combination of two or more separate touch-sensors with common processing to allow the use of a wider portfolio of touch technologies, even such, which would otherwise only offer single-touch capabilities, for multi-touch applications. Additionally, the usage of multiple separated sensors allows coverage of surfaces of forms that would, if covered with a single large sensor, cause high costs or even make it impossible for some sensor technologies to be used. The segmented ergonomically formed touch sensitive devices use ergonomic single-touch and multi-touch gestures for controlling or passing general input information to electronic devices having a human-machine input. The devices fit a variety of surface conditions and are operable via a combination of a number of different human body parts. In particular, the multiple touch sensors are ergonomically separated or dedicated to some body parts such that the user is easily able to keep for example one of their fingers (finger_1) on one sensor (sensor_1) and another finger (finger_2) on other sensor (sensor_2) without accidentally touching sensor_1 with finger_2 or vice versa.

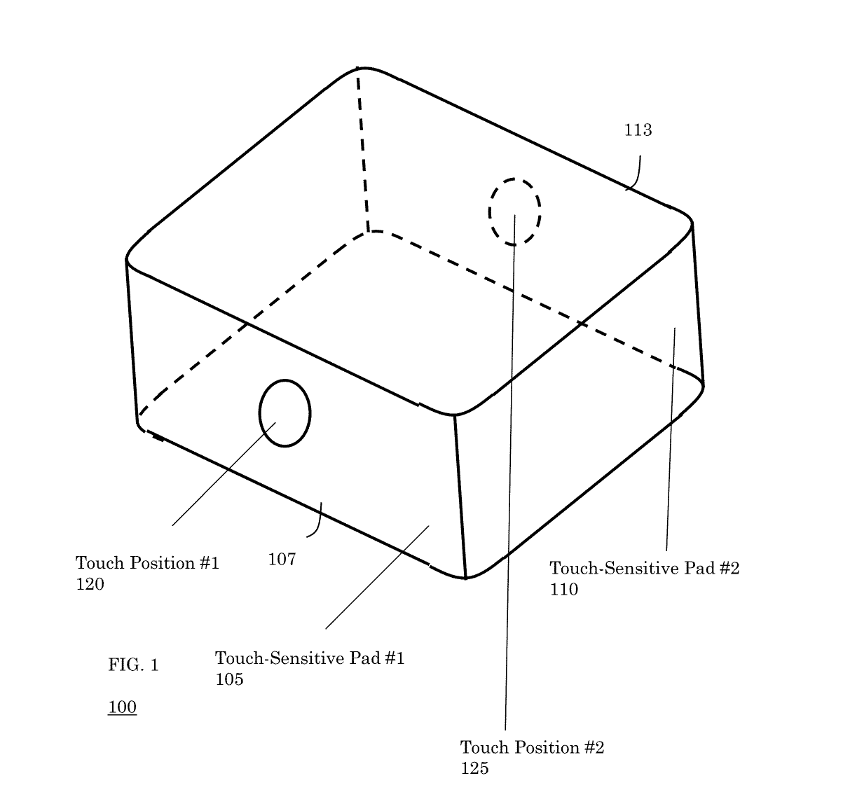

FIG. 1 is an embodiment of a HMI device, namely, a touch sensitive device 100. The touch sensitive device 100 offers multi-touch capability and recognition of ergonomic touch gestures using multiple touch sensors each of which may be implemented using single-touch capable technologies. The touch sensitive device 100 includes two or more touch-sensitive pads (TSP)−TSP #1 105 and TSP #2 110, which are advantageously positioned on different planes or surfaces 107 and 113, respectively, of the touch sensitive device 100. In particular, the TSPs 105 and 110 are positioned such that one (or one group of the) TSP(s) can be comfortably touched by a user's thumb while the other one (or the other group of) TSP(s) can be comfortably touched by the user's finger(s) of the same hand. For example, a user's thumb may be positioned on touch position #1 120 and the user's finger(s) may be positioned on touch position #2 125. In general, each user digit, body part, prosthetic and the like (herein “activation member”) has a dedicated TSP on or over which the activation member resides, i.e. touching or not touching, the surface of the device.

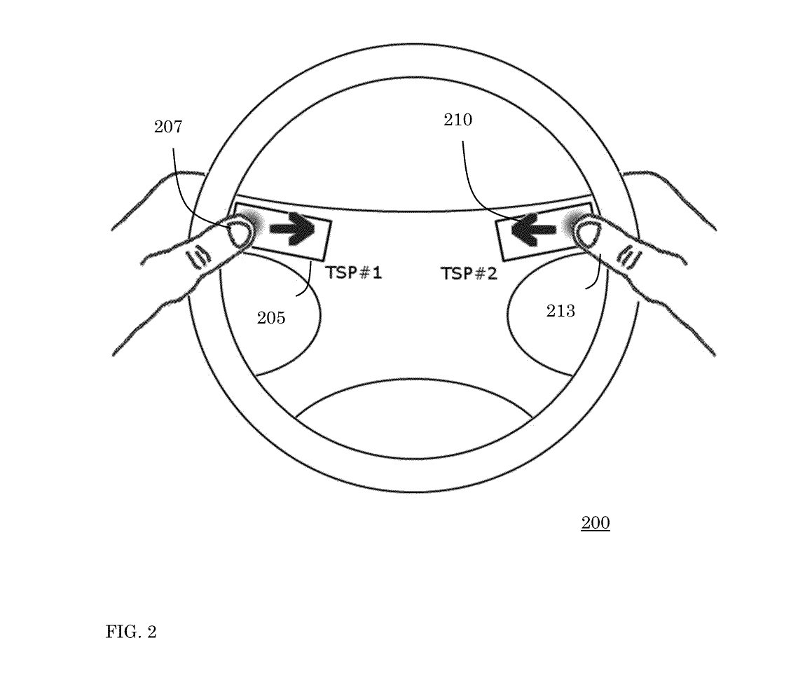

In another embodiment, the TSPs are not co-located but are electrically connected so that activation members that are not part of the same hand, for example, may operate the touch sensitive device. For example, a user driving a car may have TSPs on different sections of the steering wheel to perform certain types of activities. In this embodiment, an activity requiring a multiple touch gesture would not require the user to take the user's hands off of the steering wheel and can be accomplished by touching the TSPs with two different fingers located on two different hands. FIG. 2 shows an example steering wheel 200 with TSP #1205 for a left activation member 207 and a TSP #2 210 for a right activation member 213. The TSP #1 205 and TSP #2 210 would be electronically connected to a common processing system (not shown) as described herein.

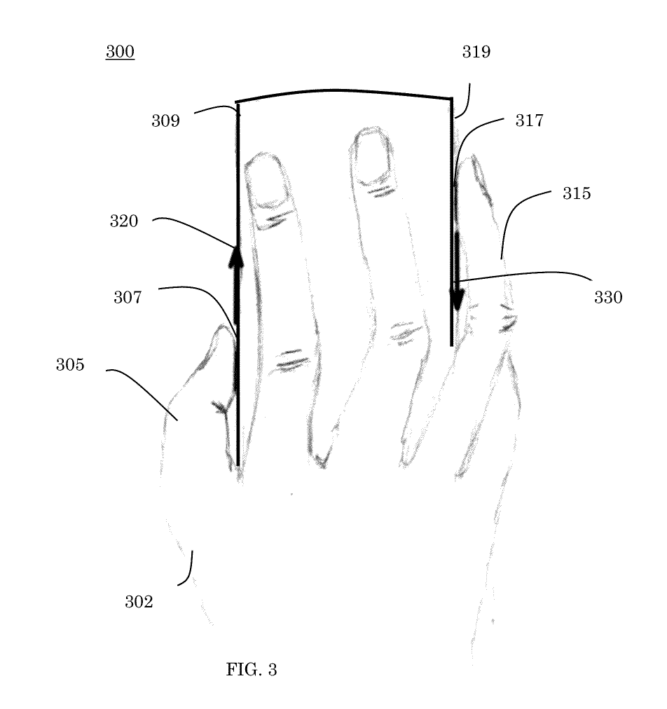

Referring now to FIG. 3, there is shown a touch sensitive device 300 with a user's hand 302 positioned on the touch sensitive device 300 so that a thumb 305 is positioned at a touch position 307 on a first side 309 and at least one finger 315 is positioned on a touch position 317 on a second side 319. The user's hand 302 can move the thumb 305 and finger 315, for example, in a first direction 320 or a second direction 330. Although only two directions are shown in FIG. 3, other directions are available as illustrated herein below. Many combinations or permutations of gestures are available to the user. For example, but not limited to, the activation members may both move in the same direction, in opposite directions or one activation member may remain in position while the other activation member moves in one direction or force is applied thereon.

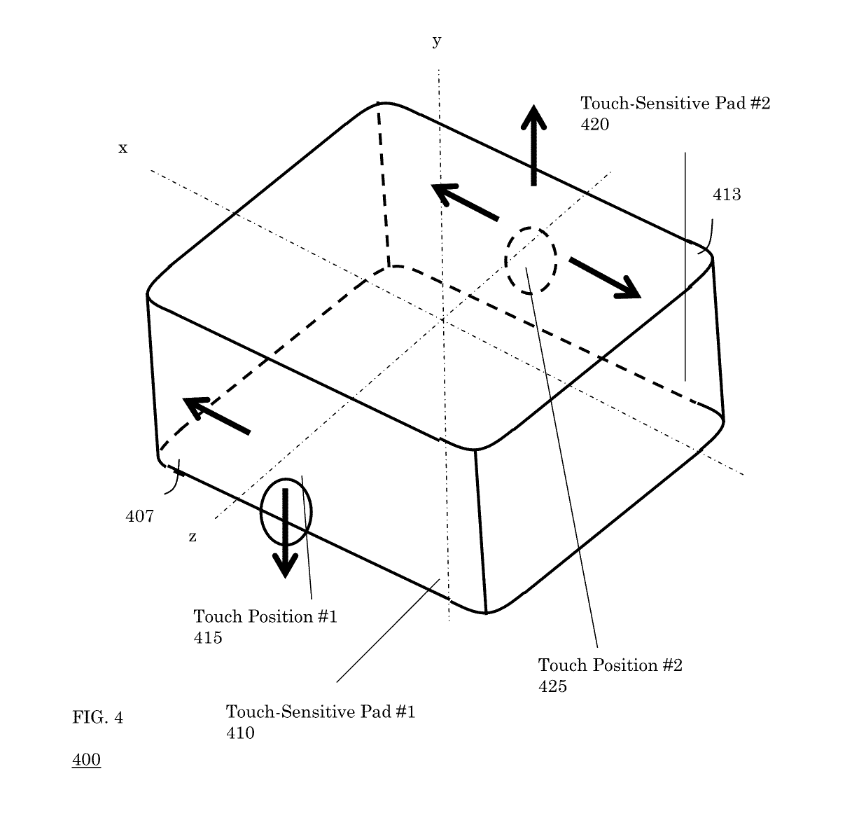

Referring now to FIG. 4, there is shown an embodiment of a human-machine input (HMI) device, namely, a touch sensitive device 400. As stated herein above, the touch sensitive device 400 offers multi-touch capability and recognition of ergonomic touch gestures using multiple touch sensors each of which may be implemented using single-touch capable technologies. The touch sensitive device 400 includes two or more TSPs #1 410 and TSP #2 420, which are advantageously positioned on different planes or surfaces 407 and 413, respectively, of the touch sensitive device 400. In particular, the TSPs 410 and 420 are positioned such that one (or one group of the) TSP(s) can be comfortably touched by a user's thumb while the other one (or the other group of) TSP(s) can be comfortably touched by the user's finger(s) of the same hand. For example, a user's thumb may be positioned on touch position #1 415 and the user's fingers may be positioned on touch position #2 425.

In an embodiment, the TSPs, for example, TSPs 410 and 420, are capable of measuring one dimension (1D), such as the x axis position or y axis position as shown in FIG. 4. In another embodiment, the TSPs are capable of measuring in 1D plus are capable of measuring force (F) (collectively 1D+F). In FIG. 4, this is shown as the x axis position or y axis position plus measuring the force or pressure along the z axis. In another embodiment, the TSPs are capable of measuring two dimensions (2D), such as the x axis position and y axis position. In another embodiment, the TSPs are capable of measuring in 2D plus are capable of measuring F (collectively 2D+F). The above measurements may be done or implemented using commercially available TSPs that may be, for example, single touch capable sensor technology. These may include, but are not limited to, resistive or capacitive touch-pads or sliders, force-balance based touch sensors and the like. These single touch capable sensors are generally less expensive and require simpler processing than multi-touch capable touch sensors.

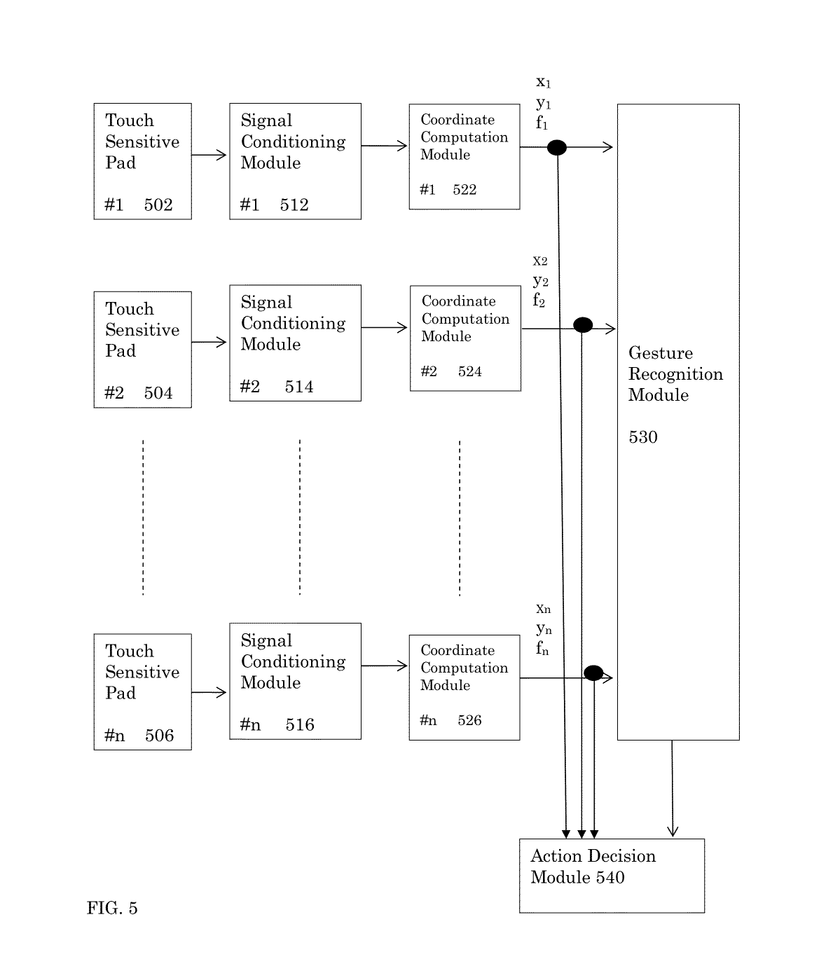

Referring now to FIG. 5, there is shown a high level block diagram of a touch sensitive device 500 which includes n TSPs: TSP #1 502, TSP #2 504, through TSP #n 506. Each of the TSPs, TSP #1 502, TSP #2 504, through TSP #n 506, are connected to respective signal conditioning modules (SCM) #1 512, SCM #2 514, through SCM #n 516.

Each SCM is specifically designed for the touch technology of the respective TSP. When various touch technologies are used for different TSPs, the corresponding SCMs will have various implementations accordingly. Depending on the TSP's technology and system requirements, SCMs may incorporate but are not limited to amplifiers, impedance converters, overvoltage or other protections, sampling circuits, A/D converters or combinations thereof. Generally the tasks of such SCMs may include but are not limited to supplying the TSPs with electrical or other energy, gathering information from the TSPs by measuring physical quantities carrying information about touch events, amplifying, modulating, sampling or otherwise converting the measured signals so that they can be further processed.

The SCMs, SCM #1 512, SCM #2 514, through SCM #n 516 transfer the conditioned signals to coordinate computation modules (CCM) #1 522, CCM #2 524, through CCM #n 526. Specifically, the SCMs, SCM #1 512, SCM #2 514, through SCM #n 516 are connected to the CCM #1 522, CCM #2 524, through CCM #n 526, respectively. The CCMs, for example CCM #1 522, CCM #2 524, through CCM #n 526, calculate the position or force from the measured values received from the TSPs, TSP #1 502, TSP #2 504, through TSP #n 506. These coordinates or force determinations are then used by the gesture recognition module 530 to determine the nature of the action performed at the TSP #1 502, TSP #2 504, through TSP #n 506 by the user. Specifically, the outputs from all the TSPs are processed together in a gesture recognition module (GRM) 530 by determining touch events based on the determined coordinates in each of the separate TSPs, by analyzing their respective movements or appearances, including time properties like speed of the movements, or order of appearance of particular events and thus recognizing the gestures and their properties. The information about determined gestures and other information about touch events is then processed by an appropriate system or application or action decision module (ADM) 540 which decides about appropriate actions.

The functional blocks in the block diagram of the touch sensitive device 500 in FIG. 5 may be implemented in various ways using various physical parts (electronic components). Therefore the separation of the functional blocks may not correspond to the actual separation of the physical components in a specific application. It is, for example, possible that some functional blocks are realized together in a single physical component such as an Application Specific Integrated Circuit (ASIC), microcontroller or other kind of device, or, on the other hand, that some functional blocks may be distributed among more than one physical component. This integration and/or segregation of functional blocks in physical components may occur in both vertical and horizontal directions (referring to block diagram in FIG. 5)—that is, for example, the functional block SCM #1 512 may be integrated horizontally with the functional block CCM #1 522 in a single physical component, or the functional block SCM #1 512 may be integrated vertically with SCM #2 514 in single physical component, or, on the other hand, single functional module, like SCM #1 512, might be implemented using two or more physical components, and so on.

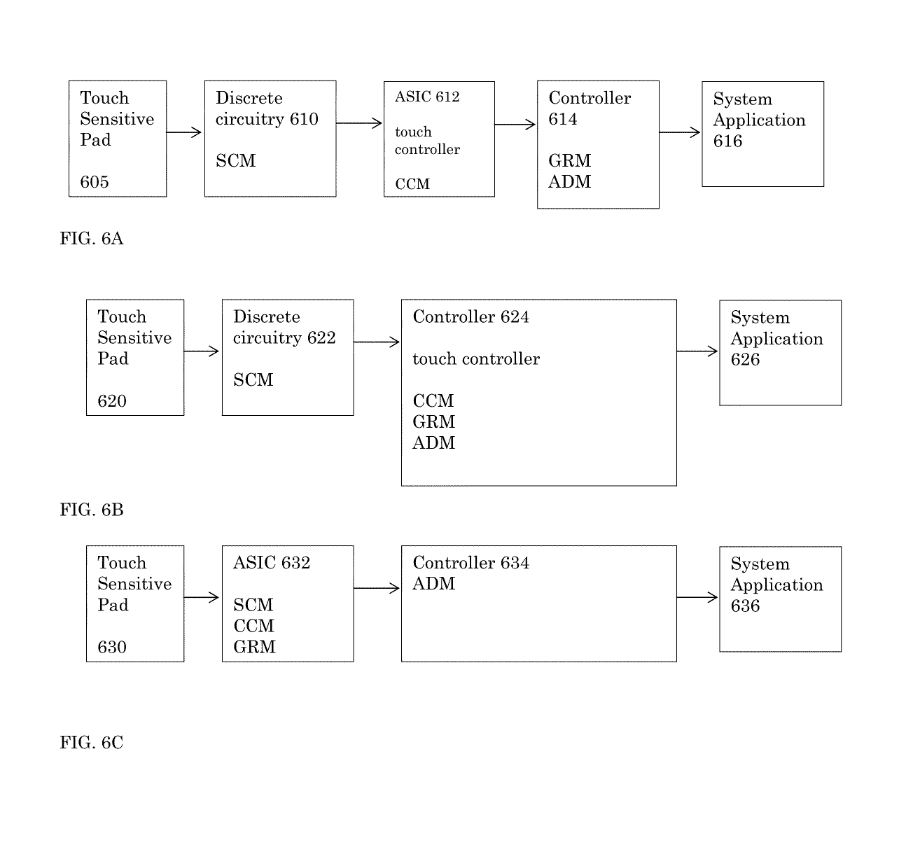

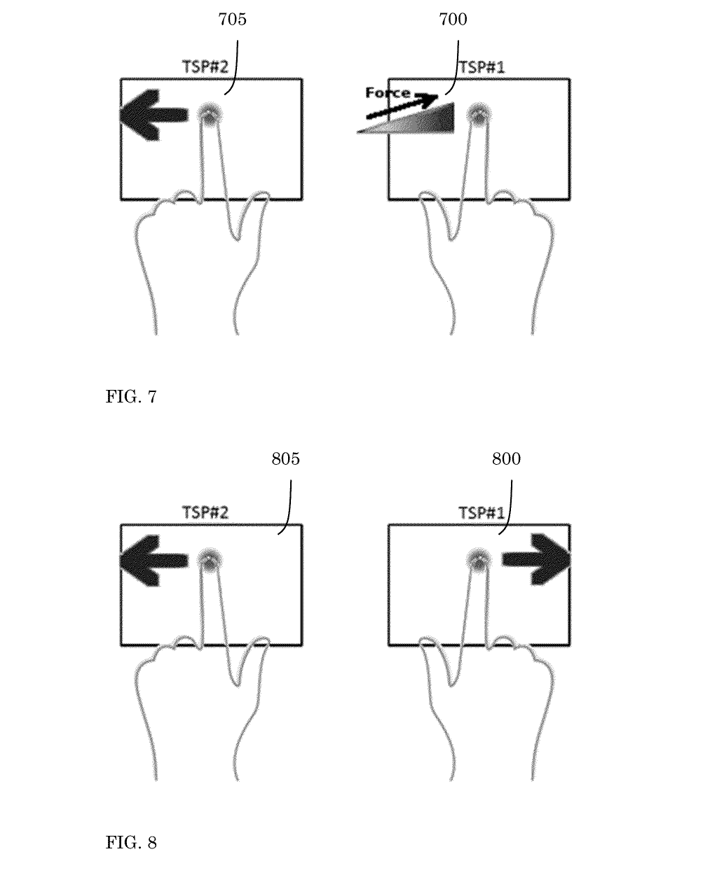

FIGS. 6A-6C provide illustrative example implementations but other implementations are possible within the scope of the disclosure herein. FIG. 6A illustrates a touch sensitive pad(s) 605 inputting signals into discrete circuitry 610 that implements SCM(s) functions. The discrete circuitry 610 is connected to an ASIC(s) 612 that works as a touch controller and implements the CCM(s) functionality. The ASIC(s) 612 is connected to a controller 614 that implements GRM and ADM functions. The controller 614 outputs to a higher system-level (system application 616). FIG. 6B illustrates a touch sensitive pad(s) 620 inputting signals into discrete circuitry 622 that implements a SCM(s) function. The discrete circuitry 622 is connected to a controller 624 that implements CCM(s), GRM and ADM functions. The controller 624 outputs to a higher system-level (system application 626). FIG. 6C illustrates a touch sensitive pad(s) 630 inputting signals into an ASIC(s) 632 that implements a SCM(s), CCM(s), and GRM functions. The ASIC 632 is connected to a controller 634. The controller 634 decides about appropriate actions (ADM function) and outputs to a higher system-level (system application 636).

In an example embodiment, but not limited to, the touch sensitive device as described herein may be used with a painting or drawing application. Referring now to FIG. 7, one TSP, for example TSP#1 700, may use a force-sensitive touch technology and may be operated by a stylus, for example. Through using the stylus on TSP#1 700 the user might be able to hand-draw lines and curves and to control the thickness of the lines drawn, opacity of the tool used or similar by controlling the force applied to the TSP#1 700. Additionally, a second TSP, for example TSP#2 705, may be operated by the user's second hand. This allows the user to combine inputs from both hands and to use two-hand gestures. For example, FIG. 8 illustrates a zoom in gesture using one hand on TSP#1 800 and another hand on TSP#2 805 and moving the hands in opposing directions. A zoom out may be implemented by moving the hands together. Other gestures may be implemented and the above are illustrative.

In another embodiment, the TSP#1 may be located under user's left foot, while TSP#2 would be located under user's right foot. Optionally, a TSP#3 and TSP#4 may be located ergonomically to be operated by a user's left and right hand, respectively. Such an input device might be used to control complex motions, like in special vehicles, manipulation or surgical robots, or to play computer games.

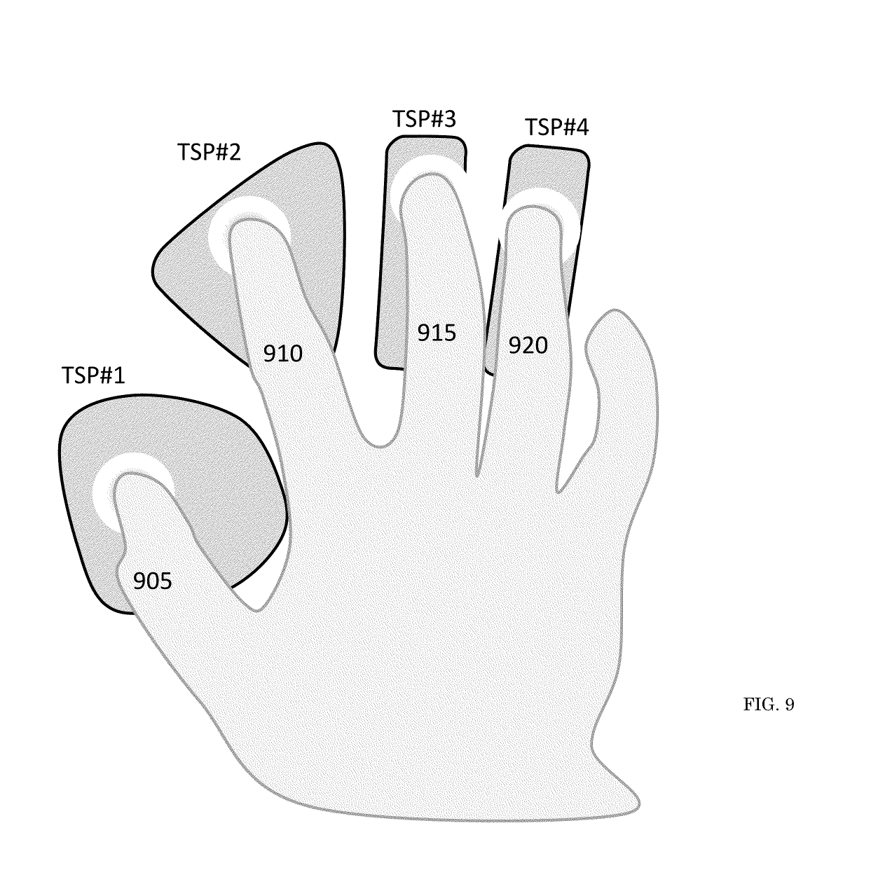

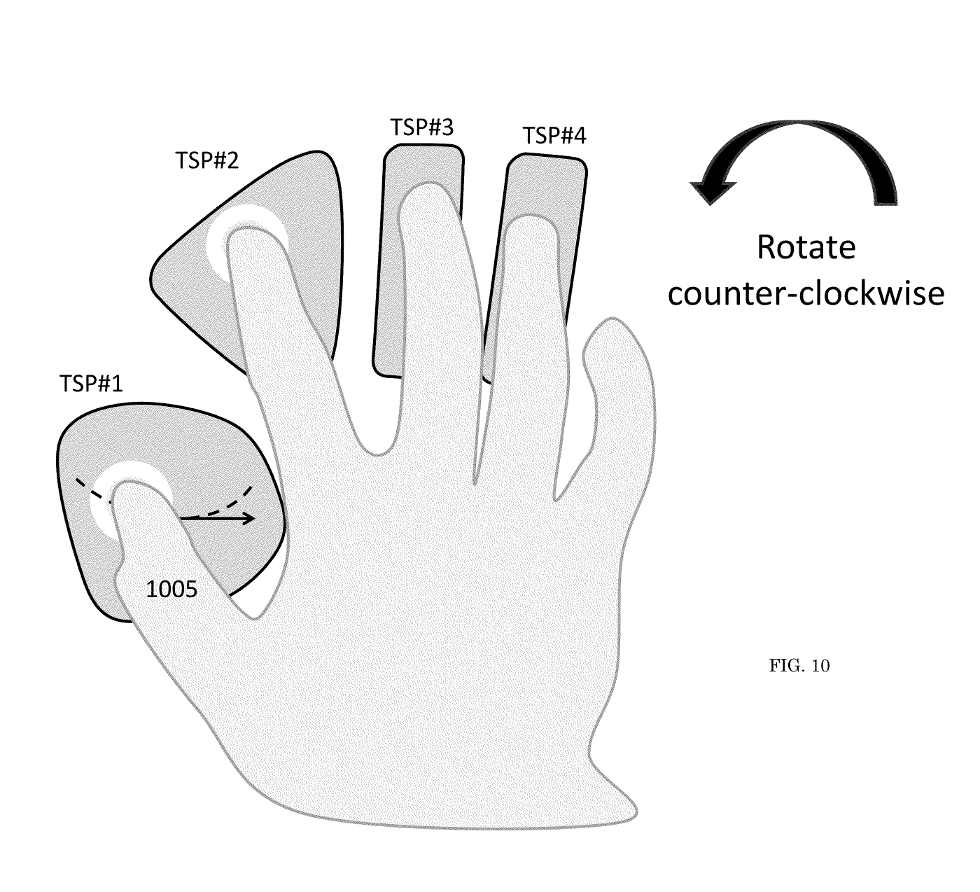

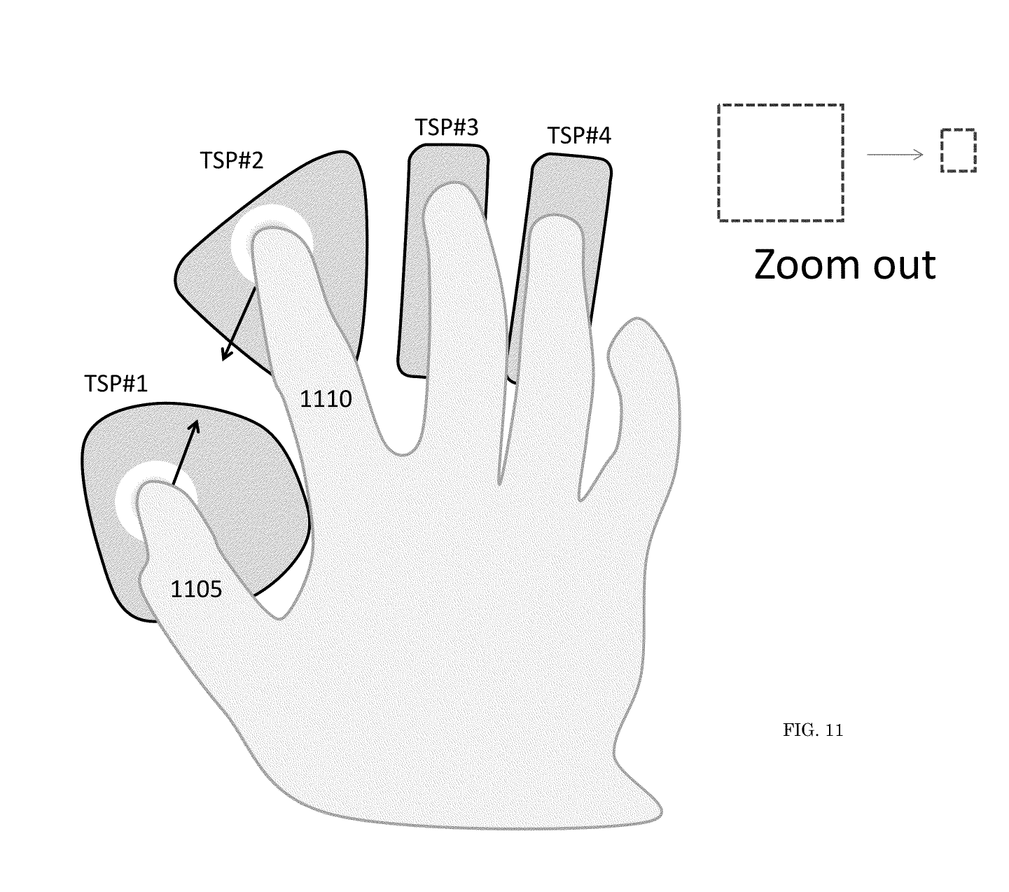

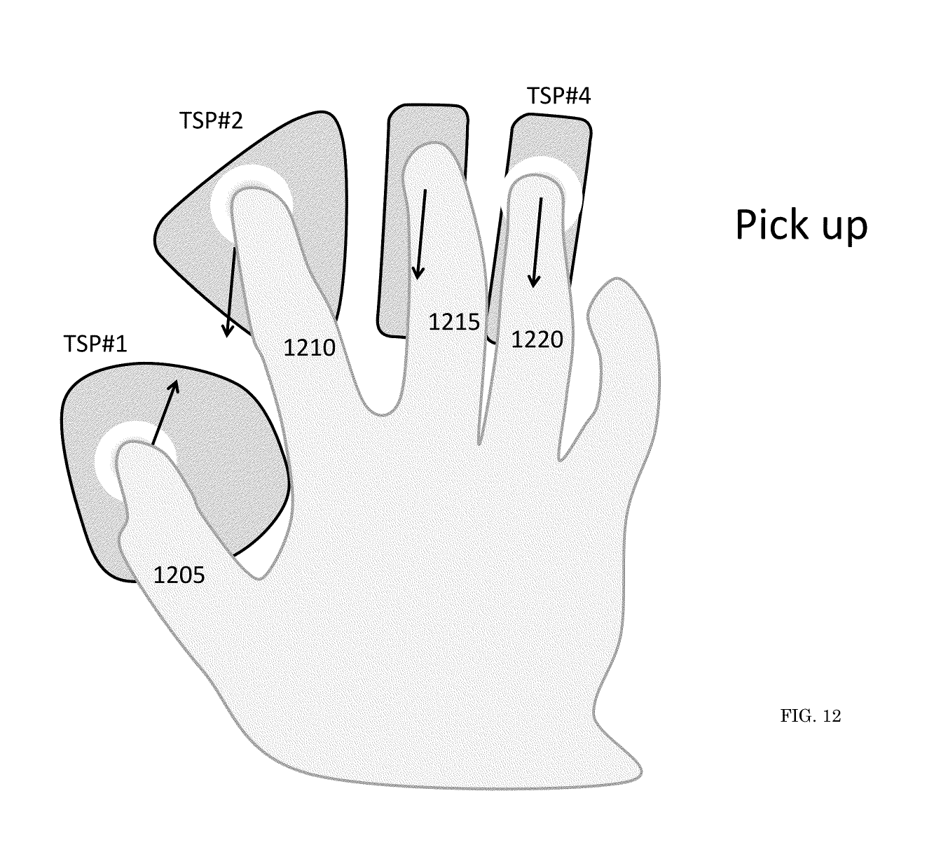

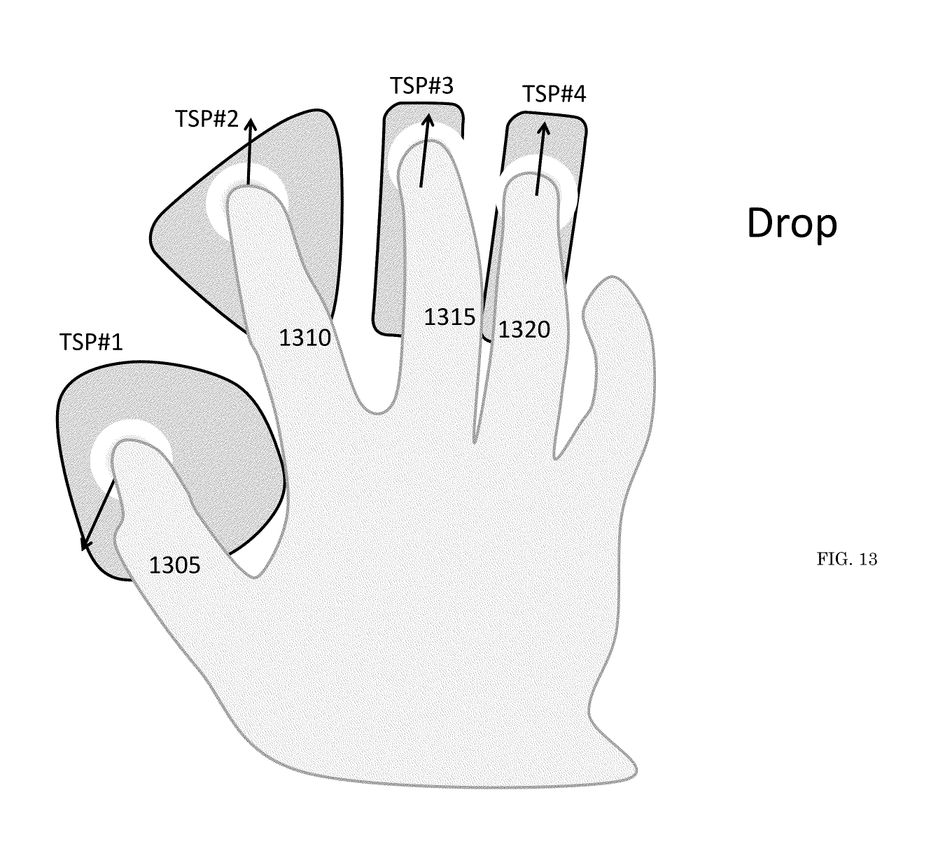

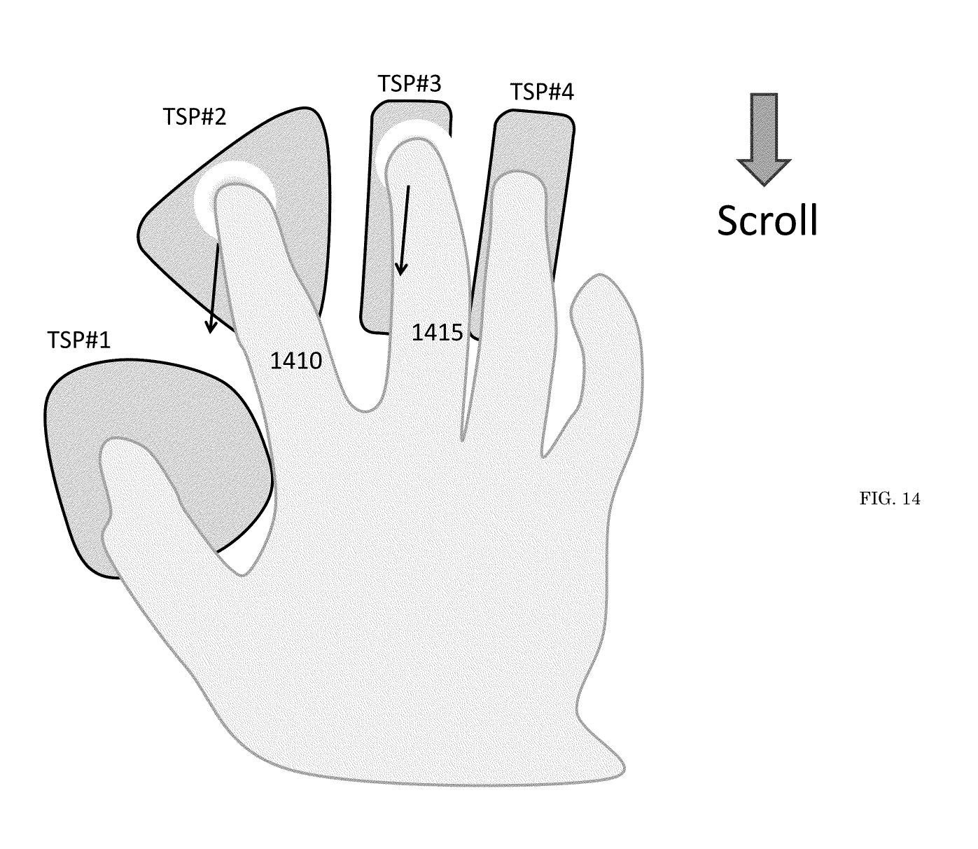

In another embodiment illustrated in FIG. 9, four touch sensitive pads TSP#1, TSP#2, TSP#3 and TSP#4 are used and dedicated to user's thumb 905, index finger 910, middle finger 915 and ring finger 920, respectively. Each of these pads may be implemented using any touch technology allowing recognition of a single touch position. At least TSP#3 and TSP#4 may use simple one-dimensional position sensors (known as sliders) instead of deploying 2D-position sensors as the ability to move in other directions is reduced by the middle finger 915 and the ring finger 920. Using 2-dimensional position measurements for recognizing the position on TSP#1 and TSP#2 allows for using any of all generally known two-finger gestures without the need for multi-touch technologies for the pads themselves. For example, FIGS. 10-14 illustrate examples of multi-finger gestures using the deployment of FIG. 9. Particularly, FIG. 10 illustrates using a user's thumb 1005 to trigger rotation in the counter-clockwise direction. FIG. 11 illustrates a zoom-out gesturing by squeezing a user's thumb 1105 and index finger 1110. FIG. 12 illustrates a pick-up gesture by squeezing user's thumb 1205, index finger 1210, middle finger 1215 and ring finger 1220 together. FIG. 13 illustrates a drop gesture by spreading out the user's thumb 1305, index finger 1310, middle finger 1315 and ring finger 1320 simultaneously. FIG. 14 illustrates a scrolling feature by dragging down or up the user's index finger 1410 and middle finger 1415 simultaneously.

The methods described herein are not limited to any particular element(s) that perform(s) any particular function(s) and some steps of the methods presented need not necessarily occur in the order shown. For example, in some cases two or more method steps may occur in a different order or simultaneously. In addition, some steps of the described methods may be optional (even if not explicitly stated to be optional) and, therefore, may be omitted. These and other variations of the methods disclosed herein will be readily apparent, especially in view of the description of the systems described herein, and are considered to be within the full scope of the invention.

Although features and elements are described above in particular combinations, each feature or element can be used alone without the other features and elements or in various combinations with or without other features and elements.

What is claimed is:

1. A human-machine input system, comprising:
a plurality of touch sensors, each of the plurality of touch sensors on an ergonomically separated surface and each of the plurality of touch sensors dedicated to an activation member;
a gesture recognition module configured to determine touch events based on position or force measurements received from the plurality of touch sensors; and
an action decision module configured to determine an action based on a determined gesture and application.

2. The human-machine input system of claim 1, further comprising:
at least one signal conditioning module connected to the plurality of touch sensors, the at least one signal conditioning module configured to at least receive measurement values from the plurality of touch sensors;
a coordinate computation module connected to each of the at least one signal conditioning module, the coordinate computation modules configured to calculate a position or force from conditioned signals received from the signal conditioning module; and
the gesture recognition module evaluating at least one of position, force, speed and information received from the coordinate computation modules to recognize input patterns or gestures.

3. The human-machine input system of claim 1, wherein each of the touch sensors together with its respective signal conditioning module and coordinate computation module performs one of only single touch measurements or performs measurements of at least two simultaneous touches.

4. The human-machine input system of claim 1, wherein each of the touch sensors together with its respective signal conditioning module and coordinate computation module is capable of measuring at least one of presence of touch (0D), touch position(s) of one or more activation members in one dimension (1D), touch position(s) of one or more activation members in 2 dimensions (2D), force or pressure of the touch (F), 0D+F, 1D+F, and 2D+F.

5. The human-machine input system of claim 1, wherein the plurality of touch sensors are located on ergonomically separated surfaces.

6. The human-machine input system of claim 1, wherein the gesture recognition module analyzes at least one of movements or appearances of touches, changes in applied force, time properties, speed of the movements or order of appearance of particular events on different touch sensors.

7. The human-machine input system of claim 1, wherein the ergonomically separated surfaces are segmented.

8. A device, comprising:
at least two touch sensors, each of the at least two touch sensors on ergonomically separated surfaces; and
a controller configured to receive position or force measurements from the at least two touch sensors, wherein the controller determines touch events by commonly processing the received position and/or force measurements from the respective touch sensors and determines actions based on recognized gestures.

9. The device of claim 8, wherein the controller is further configured to at least receive measurement values from the at least two touch sensors and calculate a position or force from conditioned signals and output calculated coordinates and force information.

10. The device of claim 8, wherein each of the touch sensors performs one of single touch measurements or performs measurements of at least two simultaneous touches.

11. The device of claim 8, wherein each of the touch sensors measures at least one of a presence of touch (0D), touch position(s) of one or more activation members in one dimension (1D), touch position(s) of one or more activation members in 2 dimensions (2D), force or pressure of the touch (F), 0D+F, 1D+F or 2D+F.

12. The device of claim 8, wherein the at least two touch sensors are located on ergonomically separated surfaces.

13. The device of claim 8, wherein the controller analyzes at least one of movements or appearances of touches or changes in applied force, time properties, speed of the movements or order of appearance of particular events on different touch sensors.

14. The device of claim 8, wherein the ergonomically separated surfaces are segmented.

15. The device of claim 8, wherein each of the at least two touch sensors is dedicated to an activation member.

16. A method for human-machine input, comprising:
providing a plurality of touch sensors, each of plurality of touch sensors on an ergonomically separated surface that is dedicated to an activation member; and
determining via a gesture recognition module touch events based on position or force measurements received from the plurality of touch sensors;

17. A method of claim 16, further comprising:
determining via an action decision module actions based on a recognized gesture.

18. The method for human-machine input of claim 17, wherein each of the touch sensors performs one of single touch measurements or performs measurements of at least two simultaneous touches.

19. The method for human-machine input of claim 17, wherein each of the touch sensors measures at least one of a presence of touch (0D), touch position(s) of one or more activation members in one dimension (1D), touch position(s) of one or more activation members in 2 dimensions (2D), force or pressure of the touch (F), 0D+F, 1D+F or 2D+F.
